(19) United States
(12) Patent Application Publication
(10) Pub. No.: US 2013/0224590 A1
(43) Pub. Date: Aug. 29, 2013

(54) ELECTROCHEMICALLY-CONDUCTIVE ARTICLES INCLUDING CURRENT COLLECTORS HAVING CONDUCTIVE COATINGS AND METHODS OF MAKING SAME

(71) Applicant: Ranjith Divigalpitiya, London (CA)

(72) Inventor: Ranjith Divigalpitiya, London (CA)

(73) Assignee: 3M Innovative Properties Company, St. Paul, MN (US)

(21) Appl. No.: 13/884,329

(22) PCT Filed: Nov. 11, 2011
(86) PCT No.: PCT/US11/60285

§ 371 Date: May 9, 2013

Related U.S. Application Data
(60) Provisional application No. 61/414,697, filed on Nov. 17, 2010.

(51) Int. Cl. H01G 11/04; H01M 4/04; H01M 4/66

(52) U.S. Cl. CPC H01G 11/04; H01M 4/661; H01M 4/0402
USPC 429/211; 361/502; 29/623.5

(57) ABSTRACT

Electrically-conductive articles are provided that include a current collector (102) having a conductive coating (104a, 104b). The current collector (102) has nanoporous structure, such as that from etched metal, and a carbon coating (104a, 104b) in contact with the current collector (102). The carbon coating (104a, 104b) is free of binder. In some embodiments, the current collector (102) includes etched aluminum. The provided electrically-conductive articles can be electrochemical capacitors or lithium-ion electrochemical cells.

### FIELD

The present disclosure relates to electrochemically-conductive articles that may be useful in energy storage devices such as electrochemical capacitors or electrochemical cells.

### BACKGROUND

Due to concerns about the decreasing availability of fossil fuels, there is increasing interest in using natural power sources such as wind and solar for future energy demands. Some of these sources do not have continuous energy production. For example, the wind does not always blow and the sun does not always shine at all times. Therefore, energy storage devices and systems are becoming increasingly in demand to allow use of energy collected from these natural sources during down times of energy production.

Electrochemical cells, such as lithium-ion electrochemical cells, and electrochemical capacitors, known as “supercapacitors”, are at the forefront of interest as potential energy storage devices. However, the performance of these energy storage devices needs to improve substantially in order to meet the higher demands of future electronic systems ranging from portable electronics to hybrid electric vehicles and large industrial equipment.

Lithium-ion electrochemical cells can provide high energy densities although they are costly. Lithium-ion batteries, however, are relatively slow to deliver power and slow to recharge.

Recently, there has been interest in developing electrochemical capacitors that can be fully charged or discharged in seconds, but have lower energy density than lithium-ion batteries. Electrochemical capacitors may have an important role in complementing or replacing lithium-ion electrochemical cells in some applications in the energy storage field such as, for example, in uninterruptable power supplies, back-up supplies used to protect against power disruption, and load-leveling.

Lithium-ion electrochemical cells and electrochemical capacitors both include electrodes that comprise current collectors. The electrodes for lithium-ion electrochemical cells typically include metal foils such as aluminum or copper foils. Electrochemically-active composite materials are then disposed upon the foils to form the electrodes. High surface area or porosity of the composite materials then allows for migration of lithium-ions into the bulk of the active materials and, thus, provides a large capacity for energy storage. Electrochemical capacitors get their high capacities by utilizing high surface area current collectors such as etched aluminum. Typically, conventional electrodes that can be useful for electrochemical capacitors can be fabricated by vapor-depositing or bonding a current collector to activated carbon. In an effort to make electrodes for electrochemical capacitors smaller and lighter, U.S. Pat. No. 7,046,503 (Hinoki et al.) discloses forming an undercoat layer comprising electrically conducting particles and a binder on a current collector by coating and then forming an electrode layer comprising a carbon material and a binder on the undercoat layer by coating. Current collectors for lithium polymer or lithium-ion electrochemical cells that include electrically-conductive metallic strips which, in turn, have a conductive coating that enhances electrical contact with the current collector have been disclosed, for example, in U. S. Pat. Appl. Publ. No. 2010/0055569 (Divigalpitiya et al.). The disclosed current collectors include a substantially uniform nano-scale carbon coating which has a maximum thickness of less than about 200 nanometers.

### SUMMARY

There is a need for electrically-conductive articles such as conductive electrodes having high conductivity and high surface area for use in, for example, lithium-ion electrochemical cells or electrochemical capacitors. There is also a need for methods of producing such electrically-conductive articles that are simple and economical. Finally, there is a need for electrically-conductive articles that can be used in energy storage systems to provide high energy capacity and high rates of power delivery.

In one aspect, an electrically-conductive article is provided that includes a current collector and a carbon coating in contact with the current collector, wherein the carbon coating is free of binder, and wherein the current collector comprises a porous metal. The porous metal can include aluminum and the aluminum can be etched. The carbon coating can include graphite and the electrochemically-conductive article can include an electrochemical capacitor which may be an electrochemical double-layer capacitor.

In another aspect, an electrically-conductive article is provided that includes a current collector and a coating in contact with the current collector consisting essentially of carbon, wherein the current collector comprises porous aluminum. The carbon can be graphite and the electrochemically-conductive article can include an electrochemical capacitor which may be an electrochemical double-layer capacitor.

In yet another aspect, a method of making an electrode is provided that includes providing a porous metal foil having a first surface and a second surface, applying carbon powder to the first surface of the porous metal foil, and polishing the first surface of the porous metal foil with an oscillating pad. The porous metal can include etched aluminum and the carbon powder can include graphite. The carbon powder can be applied by sprinkling the powder on the first surface of the porous metal, polishing the first surface by, in one embodiment, moving the oscillating pad back and forth by hand or, in another embodiment, using a power tool. The provided method also includes applying carbon powder to the second surface of the porous metal film and polishing the second surface of the porous metal foil with an oscillating pad.

In the present disclosure:
“active” or “electrochemically-active” refers to a material into which lithium can be reversibly inserted and removed by electrochemical means.

The provided electrically-conductive articles and methods of making the same can provide conductive electrodes that have high conductivity and high surface area that can be useful in lithium-ion electrochemical cells or electrochemical capacitors. The provided methods are simple, require inexpensive equipment such as buffing pads and graphite powder, and are economical. The provided electrically-conductive articles can be used in energy storage systems to provide high energy capacity and high rates of power delivery.

The above summary is not intended to describe each disclosed embodiment of every implementation of the present invention. The brief description of the drawings and the detailed description which follows more particularly exemplify illustrative embodiments.

### BRIEF DESCRIPTION OF THE DRAWINGS

FIG. 1 is a schematic drawing of a commercial supercapacitor.

FIG. 2 is a plan view of a web-coating line useful for the provided process.

FIG. 3 is a side view of the web-coating line illustrated in FIG. 2.

FIG. 4a is a top view and FIG. 4b is a grazing angle view of an etched aluminum current collector.

FIG. 5a is a top view and FIG. 5b is a grazing angle view of a provided electrochemically-conductive article made by the provided method.

### DETAILED DESCRIPTION

In the following description, reference is made to the accompanying set of drawings that form a part of the description hereof and in which are shown by way of illustration several specific embodiments. It is to be understood that other embodiments are contemplated and may be made without departing from the scope or spirit of the present invention. The following detailed description, therefore, is not to be taken in a limiting sense.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g. 1 to 5 includes 1, 1.5, 2, 2.75, 3, 3.80, 4, and 5) and any range within that range.

Lithium-ion electrochemical cells are being increasingly used to provide power for electronic devices such as power tools, cell phones, personal display devices, camcorders, toys, and hybrid electric vehicles. Although lithium electrochemical cells can have high capacity for storing energy, they tend to be slow to discharge and to recharge due to the need for lithium ions to diffuse into and out of the electrochemically active materials. Typical electrochemically active materials can include mixed metal oxides for cathodes and graphitic carbon or alloys of silicon or tin for anodes.

Electrochemical capacitors, also called super-capacitors, can also store energy. Electrochemical capacitors have a lower energy density than lithium-ion electrochemical cells but can be charged and discharged very rapidly. These devices have been shown to be useful in situations where an uninterruptible power source is needed or for load leveling. Electrochemical capacitors can function by ion absorption. These electrochemical capacitors are known as electrochemical double layer capacitors (EDLCs). There is another class of electrochemical capacitors that are known as fast surface redox reactions. These electrochemical capacitors are known as pseudo-capacitors. A review of electrochemical capacitors and materials used therein can be found, for example, in a review by P. Simon and Y. Gogotsi, Nature Materials, 7,845-854 (2008).

Electrochemical double-layer capacitors or EDLCs store charge electrostatically using reversible absorption of ions of an electrolyte onto active materials that are electrochemically stable and have high accessible specific surface area. In EDLCs charge separation occurs on polarization at the electrode-electrolyte interface forming a double layer capacitor. Capacitors follow the Helmholtz equation:

C=εᵣεₒA/d Equation (1)

where εᵣ is the dielectric constant of the electrolyte, εₒ is the dielectric constant of a vacuum, d is the effective thickness of the double layer (charge separation distance), and A is the electrode surface area. The amount of capacitance, C, is directly proportional to the electrode surface area and inversely proportional to the charge separation distance.

In EDLCs, a diffuse layer in the electrolyte is formed due to the accumulation of ions close to the electrode surface. Thus, the distance, d, between the separated charges can be of the order of the dimensions of the diffuse layer since it may lie very close to the electrode surface. Thus, in EDLCs the distance, d, can be very small—on the order of nanometers. An electric field that stores energy in the electrolyte is produced by the charge separation. The amount of energy that an EDLC can store is directly related to the capacitance. The higher the surface area of the electrode, A, the more energy that can be stored in an EDLC.

The key to reaching high capacitance by charging the double layer in and EDLC is by using high specific surface area conductive electrode materials. For this purpose, typical electrochemical capacitors use carbon, or more specifically, graphitic carbon. Graphitic carbon has high conductivity, electrochemical stability, and open porosity. Typically, activated and carbide-derived carbons, carbon fabrics, fibers, nanotubes, and other forms of carbon are used in EDLCs due to their high specific surface area and their low cost.

Super-capacitors, also known as ultracapacitors, or electrochemical capacitors (ECs) or Electric Double Layer Capacitor (EDLC), are made by sandwiching a separator, an ion conducting membrane, between two conducting foils coated with high-surface-area carbon. The sandwich is imbued with an electrolyte, usually an organic electrolyte such a mix of acetonitrile and an ion conductor like tetraethylammonium tetrafluroborate (TEA BF₄). The electric double layer formed at high surface area carbon provides the high capacitance. Conducting metallic foil is used to connect the capacitors together and transfer electric charge to the outside world. The current collector, active material (high surface area carbon) and electrolyte are connected electrically via ions and electrons and the impedance at each interface has to be minimized to transfer charge (power) efficiently. One of the weakest interfaces in terms of impedance is between the current collector foil and the active material.

An electrically-conductive article is provided that includes a current collector and a carbon coating in contact with the current collector. The carbon coating is free of binder and the current collector includes a porous metal. As expressed above in Equation (1), the capacity of electrically conducting articles, such as electrochemical capacitors, is directly proportional to the surface area of the current collectors (known as capacitive plates). The surface area of a current collector, such as a metal foil, can be substantially increased by etching. Typically, the metal foil can be copper, nickel, stainless steel, or aluminum. Aluminum is typically used in electrochemical capacitors. Aluminum has been etched before use as a current collector in order to remove the insulating, high interfacial impedance that can be produced by native oxide layers on its surface. For example, U.S.Pat. No. 5,591,544 (Fanteux et al.) teaches etching aluminum current collectors with an etching agent such as hydrochloric acid and copper chloride to remove the native oxide layer followed by priming the etched surface of the current collector with a primer that can include carbon and a transition metal oxide to passivate the surface and to provide a hydrophilic surface on the current collector surface. Etched aluminum foils, useful for electrochemical capacitors, are commercially available from, for example, Hitachi Chemical Co., America, Ltd., Boston, Mass. or from the JCC group of Japan Capacitor Industrial Co., Ltd, Tokyo, Japan under the tradename, 30CB. Etched aluminum has a nanoporous structure having pores with an average size of less than about 100 nanometers, less than about 50 nanometers, or even less than about 10 nanometers.

The provided electrically-conducting articles also have a carbon coating in contact with the current collector. The carbon coating is free of binder. The carbon coating can include carbon and additional components. The carbon can be any form or type of carbon. Exemplary carbon useful in the provided electrodes include conductive carbons such as graphite, carbon black, lamp black, or other conductive carbon materials known to those of skill in the art. Typically, exfoliatable carbon particles (i.e., those that break up into flakes, scales, sheets, or layers upon application of shear force) are used. An example of useful exfoliatable carbon particles is HSAG300, available from Timcal Graphite and Carbon, Bodio, Switzerland. Other useful materials include, but are not limited to SUPER P and ENSACO (Timcal).

The carbon coating can be applied as a dry composition (with substantially no solvent present). An exemplary process for applying the carbon coating as a dry composition can be found, for example, in U.S. Pat. No. 6,511,701 (Divigalpitiya et al.). This process, which is described later in more detail, can provide very thin, nano-scale coatings of carbon on etched metallic substrates. Surprisingly, when a carbon coating is applied as a dry composition onto etched metallic substrates having nanoporosity such as etched aluminum, the nanoporosity of the substrate is substantially maintained after the carbon coating has been applied.

In another aspect, an electrically-conductive article can include a current collector having as described above and a coating in contact with the current collector wherein the coating consists essentially of carbon. No other active materials or binders can be present in the coating. The coating can include graphite and the article can be included in an electrochemical capacitor such as an electrochemical double-layer capacitor.

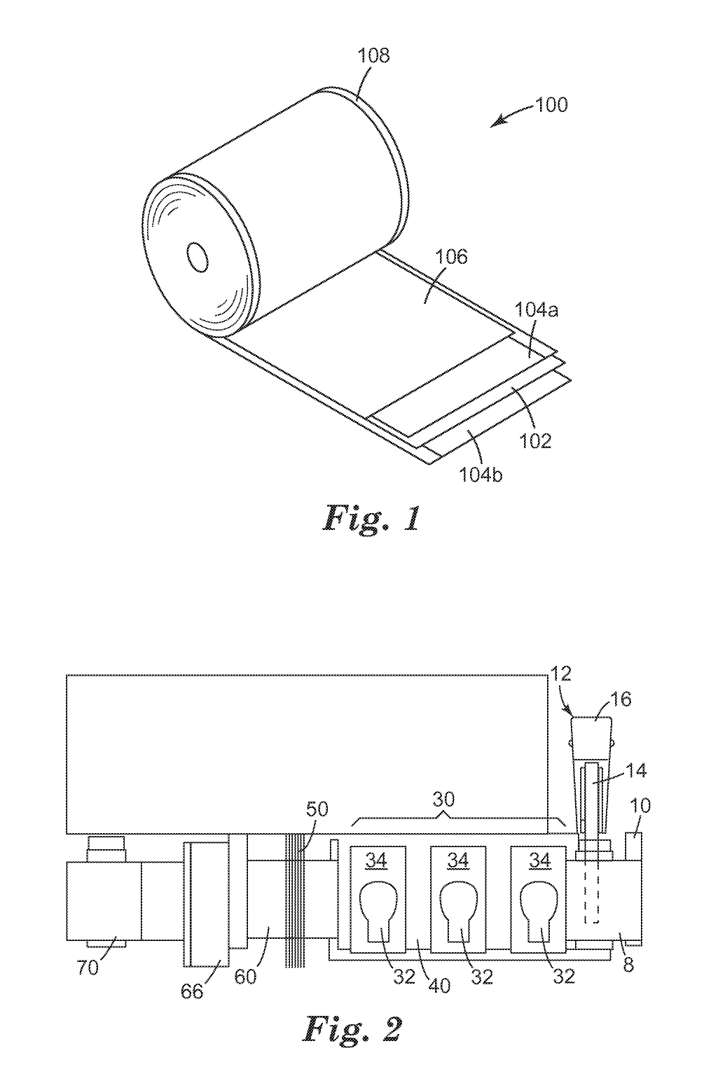

FIG. 1 is a schematic illustration of an electrochemical capacitor that is commercially available. Electrochemical capacitor 100 includes aluminum foil substrate 102 that have carbon coatings 104a and 104b coated onto both sides of the substrate. Separator 106, which can be any insulating material which is porous to electrolyte is placed on top of one side of the carbon-coated substrate. Typically, poly(vinylidene fluoride) can be used. The layered structure can then be rolled to form spool 108 which can subsequently be placed in a canister or can that includes electrolyte. To be operational, electrically-conducting leads (not shown) need to be attached to the appropriate parts of the capacitor.

In another aspect, a method of making an electrode is provided that includes providing a porous metal foil such as aluminum or etched aluminum. The porous metal foil has a first surface and a second surface. Typically, since the metal is a foil, the first surface and the second surface are opposing each other. Carbon powder is applied to the first surface of the metal foil. The carbon powder can be applied by sprinkling the powder by hand, applying the powder by machine, or any other manner of application in which the powder is introduced onto the surface of the porous metal film. In some embodiments, the powder can be sprinkled randomly onto the first surface of the porous metal foil. In all embodiments, the carbon powder is applied as a dry powder with no coating solvent or binder present. The carbon powder can be graphite as described above.

After the carbon powder is applied to the first surface of the metal foil, it is polished with an oscillating pad. The oscillating pad can be moved over the first surface of the metal foil which has carbon powdered sprinkled thereon. The pad can move back and forth over the metal foil surface or can be moved rotationally around an axis perpendicular to the first surface of the metal foil. In some embodiments, the oscillating pad can be moved using an orbital motion and can move in a plurality of directions during the polishing operation. The oscillating pad or buffing applicator can move in an orbital pattern parallel to the surface of the substrate with its rotational axis perpendicular to the plane of the substrate. The buffing motion can be a simple orbital motion or a random orbital motion. The typical orbital motion used is in the range of 1,000-10,000 orbits per minute.

The polishing can be accomplished manually by moving the oscillating pad back and forth on the metal foil surface that contains the carbon powder using hand motions. Alternatively the polishing can be accomplished using a power tool. Power tools such as finishing sanders can be useful for the purposes of the provided method. Finishing sanders are commercially available from many manufacturers including Makita USA, La Mirada, Calif. and Black and Decker, Baltimore, Md.

Oscillating pads for use in the provided method may be any appropriate material for applying particles to a surface. For example, the oscillating pad may be a woven or non-woven fabric or cellulosic material. Alternatively, the pad may be a closed cell or open cell foam material. In yet another alternative, the pad may be a brush or an array of bristles. Preferably, the bristles of such a brush have a length of about 0.2-1 cm, and a diameter of about 30-100 microns. Bristles are preferably made from nylon or polyurethane. Typical buffing applicators include paint applying tools that include short fibers or mohair, such as those described in U.S. Pat. No. 3,369,268 (Burns et al.), lamb's wool pads, 3M PERFECT-IT polishing pads, available from 3M, St. Paul, Minn. The provided method also includes the above method and further includes applying carbon powder to the second surface of the porous metal foil and then polishing the porous metal foil with an oscillating pad.

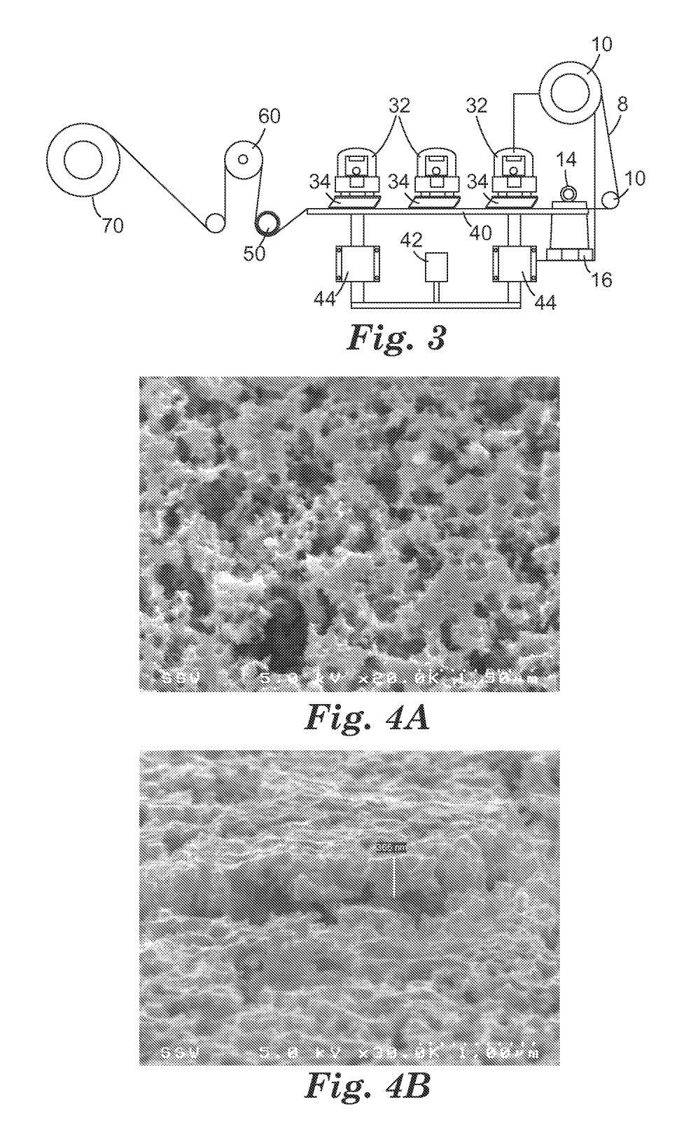

The coating and polishing operations can be automated and performed upon a web-coating line. An exemplary web coating line for the provided method is shown in FIG. 2 and FIG. 3, where buff process is a clutched off-wind station 10 for a roll of base material (porous metal foil), a powder feed station 12 that presents materials to be buffed onto the web base material, a buffing station 30, a web pacer drive station 60 which drives the web at a regulated speed, and a clutch driven take-up roll 70. The system also includes various directing and idler rolls (not shown) and may also include post buffing wiping means for non-buffed web surface and/or a thermal device to improve fusing of materials buffed to the web.

The illustrated web coating line includes a powder dispensing station 12, the buffing station 30, the web wiping station 50. A 30:1 gear reduction was added to the web pace drive system 60 to provide for more precise control of slower web speeds. Most controls are independent of each other to allow for maximum flexibility in determining process control parameters.

Powdered materials to be polished onto the porous metal web 8 are deposited on the web from a feeder system 12 that has considerable scope in its delivery capability. Feeder system 12 consists of tube 14 with a powder reservoir 16 attached, and a helical brush (not shown) mounted inside the tube. The brush is coupled to a geared motor drive (not shown). The powder feed typically has two timers controlling the rate and duration of rotation of powder reservoir 16. Materials are loaded into reservoir 16 that is mounted on the powder feeder. The reservoir may contain a tube mounted within a tube. Both tubes contain orifices to dispense powders. At least one orifice, or set of orifices, is situated above web 8 to distribute the powder in desired concentration across the width of the web. A mesh screen may be included between the tubes to aid in controlling powder dispensing or alternatively powder may be dispensed though the mesh alone. Alternately a modified vibratory feed may be employed in dispensing powder. For example, Model F-TO, from FMC Corporation, Homer City, Pa. was used. This vibratory feed may be modified to increase the uniformity of the powder application. The biased spring action of the vibrator may be changed to align vertically to shake the powder back and forth in the dispensing tube, thereby avoiding packing of the powder. The vertical component of the vibrator action will be identical in both stroke directions.

The rotary buffing action is parallel to the web surface and is accomplished by an orbital sanding device 32 that has been modified to accept buffing pads 34 of specific configuration and materials. This is affected in the process prototype by a succession of three air-driven orbital sanding devices 32 and associated buffing pads 34.

Alternatively, an electric orbital sander such as Black and Decker model 5710 with 4000 orbital operations per minute and a concentric throw of 0.1 inch (0.2 inch overall) may be used. Typically, the concentric throw of the pad is greater than about 0.05 inch (0.1 inch overall). The air powered orbital sanders used in the process prototype have operational speeds and concentric throw similar to the Black and Decker model 5710 and are from Ingersol-Rand, Model 312 Orbital Sander, Dublin, Ireland, with a free speed of 8000 operations per minute at 621 kilopascal (kPa) air pressure. With reduced air pressure supplied and increased application pressure the actual operating speeds are in the 0 to 4000 operations per minute range. The three sanders are fed from a common air line (not shown) connected to an adjustable 0 to 689 kPa psi air regulator (not shown) which allows the operator to adjust the buffing speed. There is an on-off air control to actuate these sander/buffers. All of the sanders described have a rectangular orbital pad of approximately 9 cm×15.25 cm. On the web buffing operation the web is moved with the shorter side of the buffing pad parallel to web direction. Thus, the 15.25 cm length of the buffing pad is transverse to the machine direction.

Three orbital sanders 32 are fixed in position. Below these sanding devices is a smooth plate 40 that can be driven upward to sandwich the web between the buffing pads and the plate, thus applying buffing pressure to the web. A precision air pressure regulator, 0 to 345 kPa, supplies air to an air cylinder 42 that is connected to the plate to drive it upwards. The plate weight is compensated by air pressure such that at approximately 241 kPa pressure the plate applies minimum (near zero) pressure to the web and buffing pads. At 345 kPa, the pressure applied to the web is equivalent to the pressure that would be applied in normal sander operation where the weight of the sander plus a few pounds of downward hand pressure is used. The reason for this type of pressure is that the buffing process does not require high pressures to be applied to the web to achieve the desired results. Excessive pressure can damage the web surface including such defects as scratches and melting or warping the web from the heating affects of friction. Generally, excessive pressure of the sanders/pads to the web does not produce a uniform coating of the web. Two precision guide bearings assist in maintaining the plate travel vertically and stabilizing the plate such that buffing action and energy is not lost in plate movement. An on-off air control allows the operator to actuate the plate.

The orbital sanders 32 used in the illustrated process are used to polish or buff the web. No abrasive material is used. The lower orbiting platen of the sander is modified to accept a buffing pad 34 that may also be modified. The oscillating pads 34 are described in U.S. Pat. No. 3,369,268 (Burns et al.) They are approximately 20 cm long and 9 cm wide and are a laminate construction of a thin metal backing, a 1.27 cm thick layer of open-celled polyurethane foam with an active surface of soft, very fine, densely piled nylon bristles 0.5 cm thick. These pads are designed and marketed as a paint applicator. The pads are modified such that they can be easily mounted to the orbital sanders. The process design has included the dimensional ability to increase the lateral stroke of the Ingersol-Rand sanders to 1.27 cm.

Typically, grooves of approximately 0.3 cm wide and 3.8 cm long are cut into the leading edge bristles of pad 34 in the web travel direction to facilitate the incorporation into the pad 34. The grooves were spaced approximately 1.6 cm apart creating a comb-like appearance to the lower pad surface. Optical scanning of buffed web, which was produced with this pad, showed very even coating weight with no apparent variation across the web. Additionally, pad 34 may be modified by bending the leading edge of the pad upward to produce a more gradual interface of bristles to web surface. This was incorporated in the “comb” style pad. These modifications to the pad to convert it to a buffing pad were only required on the first pad employed in the process. Subsequent pads in the process were not modified as they primarily finish out the buffing process. Alternatively, a stationary pad may be mounted between the orbital pads and the powder dispenser. With a stationary pad, the dispensed powder was applied onto the web quickly before the powder had a chance to move around, assuring that the excess powder was kept on the substrate.

A paint roller 50 was provided prior to the pacer roll 60 to wipe any excess powder from the surface of the buffed web 8. The pacer roll 60 was knurled on its drive surface. The potential for the knurls to scratch the web surface existed. The pacer roll 60 was coated with rubber to alleviate this problem.

The provided electrochemically-conductive articles made by the provided method allow for a fast, economical method of making high surface area current collectors that have carbon coatings and function well as electrodes in electrochemical capacitors. The applied carbon substantially coats the nanoporous structures of the current collector without substantially reducing the surface topography. The coating is very thin—probably on the order of 100 nm or less in most location. The graphite might have a structure that might resemble layered carbon and might contain fragments of carbon nanotubes or graphene. In any case, the provided electrochemically-conductive article has high conductivity and high surface area as required for use in electrochemical capacitors.

Objects and advantages of this invention are further illustrated by the following examples, but the particular materials and amounts thereof recited in these examples, as well as other conditions and details, should not be construed to unduly limit this invention.

### EXAMPLES

### Example 1

A 20 micron thick sheet of etched Al foil (15.3 cm'26.7 cm available from Toyo Aluminum K K, Japan) was attached to a glass plate with adhesive tape. HSAG300 graphite powder (available from Timcal, Bodio, Switzerland) was sprinkled randomly on to the foil. Using a Makita Sheet Finishing Sander (Model B04900V from Makita Company, Whitby. Ontario, Canada) fitted with a paint pad (EZ PAINTR from Shur-Line, Huntesville, N.C.) and a speed setting of 2, the foil was polished by moving the sander back and forth manually. The sander was removed from the foil after 8 seconds at which time a uniform grey colored coating was observed to be deposited on the foil.

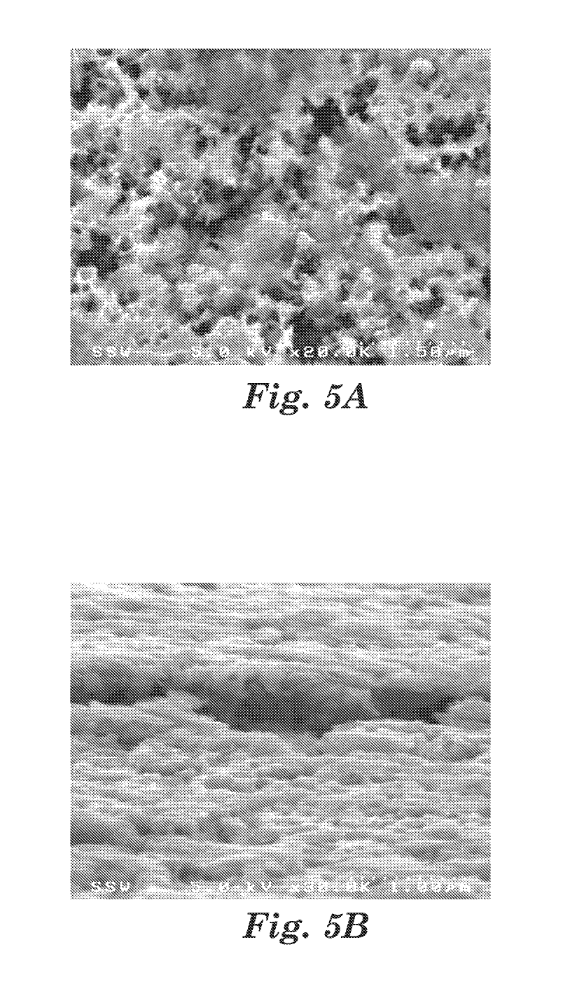

The sample was tested as a current collector and found to be functional with acceptable performance A similar sample was imaged and compared to a sample not treated with graphite using scanning-electron microscopy (SEM) to determine the morphology of resulting coating. FIGS. 4a, 4b show the nanoporous aluminum current collector. The sample in FIG. 4b was intentionally cracked by bending it 180° to allow an edge-on view of the surface. The porosity of the nanoporous current collector is observed to extend at least 365 nm in from the surface. FIGS. 5a and 5b show the images of a nanoporous aluminum current collector after powder graphite has been polished (for 8 seconds) onto the nano-porous foil according to the provided method. These SEMs show that the application and polishing of graphite does not seem to change the topography of the sample as viewed in FIGS. 5a and 5b. The nanoporous structure of the current collector surface is preserved. And the samples function well as electrodes in electrochemical capacitors.

### Example 2

Same method as in Example was used to coat etched aluminum using buff coatings of different durations (8 sec., 15 sec., and 30 sec.). All of the samples tested positively as current collectors.

Following are exemplary embodiments of an electrochemically-conductive articles including current collectors having conductive coatings and methods of making same according to aspects of the present disclosure.

Embodiment 1 is an electrically-conductive article comprising: a current collector; and a carbon coating in contact with the current collector, wherein the carbon coating is free of binder, and wherein the current collector comprises a porous metal.

Embodiment 2 is an electrically-conductive article according to embodiment 1, wherein the porous metal comprises aluminum.

Embodiment 3 is an electrically-conductive article according to embodiment 2, wherein the porous metal comprises etched aluminum.

Embodiment 4 is an electrically-conductive article according to embodiment 1, wherein the carbon coating comprises graphite.

Embodiment 5 is an electrically-conductive article according to embodiment 1, wherein the article comprises an electrochemical capacitor.

Embodiment 6 is an electrically-conductive article according to embodiment 5, wherein the electrochemical capacitor is an electrochemical double-layer capacitor.

Embodiment 7 is an electrically-conductive article comprising: a current collector; and a coating in contact with the current collector consisting essentially of carbon, wherein the current collector comprises porous aluminum.

Embodiment 8 is an electrically-conductive article according to embodiment 7, wherein the carbon comprises graphite.

Embodiment 9 is an electrically-conductive article according to embodiment 7, wherein the electrochemically-conductive article comprises an electrochemical capacitor.

Embodiment 10 is an electrically-conductive article according to embodiment 9, wherein the electrochemical capacitor is an electrochemical double-layer capacitor.

Embodiment 11 is a method of making an electrode comprising: providing a porous metal foil having a first surface and a second surface; applying carbon powder to the first surface of the porous metal foil; and polishing the first surface of the porous metal foil with an oscillating pad.

Embodiment 12 is a method of making an electrode according to embodiment 11, wherein the porous metal foil comprises aluminum.

Embodiment 13 is a method of making an electrode according to embodiment 12, wherein the porous metal comprises etched aluminum.

Embodiment 14 is a method of making an electrode according to embodiment 11, wherein the carbon powder comprises graphite.

Embodiment 15 is a method of making an electrode according to embodiment 14, wherein applying graphite powder comprises sprinkling the graphite powder on the first surface of the porous metal.

Embodiment 16 is a method of making an electrode according to embodiment 11, wherein the polishing comprises moving the oscillating pad back and forth by hand.

Embodiment 17 is a method of making an electrode according to embodiment 11, wherein the polishing comprises using a power tool.

Embodiment 18 is a method of making an electrode according to embodiment 11, further comprising applying carbon powder to the second surface of the porous metal foil; and polishing the second surface of the porous metal foil with an oscillating pad.

Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows. All references cited in this disclosure are herein incorporated by reference in their entirety.

1. An electrically-conductive article comprising:
a current collector; and
a graphite coating in contact with the current collector,
wherein the graphite coating is free of binder, and
wherein the current collector comprises a porous metal.

2. An electrically-conductive article according to claim 1, wherein the porous metal comprises aluminum.

3. An electrically-conductive article according to claim 2, wherein the porous metal comprises etched aluminum.

4. (canceled)

5. An electrically-conductive article according to claim 1, wherein the article comprises an electrochemical capacitor.

6. An electrically-conductive article according to claim 5, wherein the electrochemical capacitor is an electrochemical double-layer capacitor.

7. An electrically-conductive article comprising:
a current collector; and
a coating in contact with the current collector consisting essentially of graphite,
wherein the current collector comprises porous aluminum.

8. (canceled)

9. An electrically-conductive article according to claim 7, wherein the electrochemically-conductive article comprises an electrochemical capacitor.

10. An electrically-conductive article according to claim 9, wherein the electrochemical capacitor is an electrochemical double-layer capacitor.

11. A method of making an electrode comprising:
providing a porous metal foil having a first surface and a second surface;
applying carbon powder to the first surface of the porous metal foil, wherein the carbon powder is applied as a dry powder with no coating solvent or binder present; and
following the step of applying the carbon powder, polishing the first surface of the porous metal foil with an oscillating pad.

12. A method of making an electrode according to claim 11, wherein the porous metal foil comprises aluminum.

13. A method of making an electrode according to claim 12, wherein the porous metal comprises etched aluminum.

14. A method of making an electrode according to claim 11, wherein the carbon powder comprises graphite.

15. A method of making an electrode according to claim 14, wherein applying graphite powder comprises sprinkling the graphite powder on the first surface of the porous metal.

16. A method of making an electrode according to claim 11, wherein the polishing comprises moving the oscillating pad back and forth by hand.

17. A method of making an electrode according to claim 11, wherein the polishing comprises using a power tool.

18. A method of making an electrode according to claim 11, further comprising
applying carbon powder to the second surface of the porous metal foil; and
polishing the second surface of the porous metal foil with an oscillating pad.
